(19) United States
(12) Patent Application Publication
(10) Pub. No.: US 2009/0099880 A1
(43) Pub. Date: Apr. 16, 2009

(54) DYNAMIC BUSINESS PROCESS PRIORITIZATION BASED ON CONTEXT

(75) Inventors: Ronald P. Doyle, Raleigh, NC (US); Patrick J. O'Sullivan, Dublin (IE); Edith H. Stern, Yorktown Heights, NY (US); Robert C. Weir, Westford, MA (US); Barry E. Willner, Briarcliff Manor, NY (US)

Correspondence Address: STEVENS & SHOWALTER, L.L.P., BOX IBM, 7019 CORPORATE WAY, DAYTON, OH, 45459-4238, US

(73) Assignee: INTERNATIONAL BUSINESS MACHINES CORPORATION, Armonk, NY (US)

(21) Appl. No.: 11/871,366

(22) Filed: Oct. 12, 2007

(51) Int. Cl. G06F 9/44

(52) U.S. Cl. 705/7

(57) ABSTRACT

A user interface to establish dynamic prioritization of business process instances enables a user to select a business process for association with dynamic prioritization, define at least two different priority levels that correspond to the business process and to define a priority relevant context associated with the business process, where the priority relevant context is evaluated to select an execution priority level from at least two different priority levels for association with a specific instance of the business process. The user interface further enables a user to define at least one directive that is evaluated in consideration of the priority relevant context in order to select the execution priority level and is coupled to data storage to store the priority levels and the priority relevant context.

### CROSS REFERENCE TO RELATED APPLICATIONS

The present application is related to U.S. patent application Ser. No. ______, Attorney Docket IBM 071PA, entitled “Dynamic Business Process Prioritization Based On Context”, which is filed currently herewith and hereby incorporated by reference.

### BACKGROUND OF THE INVENTION

The present invention relates in general to business processes, and more particularly, to dynamic prioritization of business process instances based upon context.

A business process typically defines a flow of interrelated tasks that solve a particular issue of interest to a corresponding business entity. In practice, the flow of the business process may be carried out by one or more self-contained, modular business process applications that collectively implement the sequence of activities including decision points, branches, joining points and loops defined in the corresponding business process flow.

In a service-oriented architecture, conventional web-based business process implementations, referred to as web services, are exposed access points of business process flows that are carried out by service providers or other third party entities. In this regard, web services are controlled to meet a corresponding performance level as set out in a service level agreement (SLA) between the web service provider and a corresponding business entity. A service level agreement typically specifies the mutual understandings, guarantees and expectations of a web service to perform as part of a designated business process flow. To ensure that agreed upon performance levels are met, conventional web services are statically defined to a class of service when initiated and this static class determines the priority of the web service during execution time. As an example, a service level agreement may specify a class of service requiring “80% of transactions to be completed by a web service in 0.5 seconds and 99% of transactions to be completed in 1.5 seconds”.

Certain workload management systems, such as the zOS workload manager by International Business Machines (IBM) of Armonk, N.Y., further support the definition of multiple classes, each associated with a service level agreement. Resources are assigned or prioritized by the workload manager so that service level agreements are met. Although multiple classes are available, each business process instance is still statically assigned a class and corresponding priority level based upon its corresponding service level agreement.

### BRIEF SUMMARY OF THE INVENTION

According to an aspect of the present invention, a method of establishing dynamic prioritization of business process instances comprises selecting a business process for association with dynamic prioritization, defining at least two different priority levels that correspond to the business process and defining a priority relevant context associated with the business process, where the priority relevant context is evaluated to select an execution priority level from at least two different priority levels for association with a specific instance of the business process. The method further comprises defining at least one directive that is evaluated in consideration of the priority relevant context in order to select the execution priority level and storing the priority levels and the priority relevant context in a storage device accessible to a priority calculating component for calculating priorities of business process instances using the priority levels and the priority relevant context.

According to another aspect of the present invention, a method of providing a user interface to establish dynamic prioritization of business process instances comprises providing a first module that, when executed, selects a business process for association with dynamic prioritization, providing a second module that, when executed, defines at least two different priority levels that correspond to the business process and providing a third module that, when executed, defines a priority relevant context associated with the business process, where the priority relevant context is evaluated to select an execution priority level from the at least two different priority levels for association with a specific instance of the business process. The method further comprises providing a fourth module that, when executed, defines at least one directive that is evaluated in consideration of the priority relevant context in order to select the execution priority level and providing data storage to store the priority levels and the priority relevant context in a storage device accessible to a priority calculating component for calculating priorities of business process instances using the priority levels and the priority relevant context.

### BRIEF DESCRIPTION OF THE SEVERAL VIEWS OF THE DRAWINGS

FIG. 1 is a schematic illustration of an exemplary system that may be utilized to implement dynamic prioritization of business processes based on context according to various aspects of the present invention;

FIG. 2 is a flow chart illustrating an exemplary approach for dynamically prioritizing business processes according to various aspects of the present invention;

FIG. 3 is a block diagram of a system for dynamically prioritizing business processes according to various aspects of the present invention;

FIG. 4 is a schematic illustration of a user interface to the user tool of FIG. 3 according to various aspects of the present invention;

FIG. 5 is a flow chart illustrating an exemplary method for interacting with a user to define parameters for dynamically prioritizing business processes according to various aspects of the present invention; and

FIG. 6 is a block diagram of an exemplary computer system including a computer usable medium having computer usable program code embodied therewith, where the exemplary computer system is capable of executing a computer program product to implement dynamic prioritization of business processes based on context according to various aspects of the present invention.

### DETAILED DESCRIPTION OF THE INVENTION

According to various aspects of the present invention, a priority level may be uniquely assigned to each business process instance that is executed on a computer system. As such, specific instances of the same business process may be assigned the same or different priority level, e.g., based upon a context associated with each specific business process instance. According to further aspects of the present invention, the context upon which the priority level is set for a given business process instance is determined by one or more variables. The variable(s) may be in the business process itself, associated with the business process or not related to the business process.

In an exemplary implementation, a priority band is utilized to provide dynamic business process prioritization. As used herein, the term “priority band” is used to characterize a range, scale, measure or other conceptual organization that comprises two or more priority levels associated with a given business process. For example, software, middleware and/or framework systems may utilize a priority band to associate a selected execution priority level from a set of priority levels associated with the priority band to a corresponding business process instance. Minimum and/or maximum priorities may be optionally set to establish appropriate bounds for a given priority band. Alternatively, a given band may be unbounded in one or both directions. For example, the lower limit of a priority band could extend to a priority value of 0 (zero) and/or there may be no upper limit to the priority band.

A build time or deployment time tool may be used to query an administrative or other appropriate user to define an appropriate set of priority levels to establish the priority band for the associated business process. As a further example, an administrative or other appropriate user may enter or otherwise identify directives, e.g., rules and/or algorithms that may be evaluated to set and/or change an assigned execution priority within the corresponding priority band for an associated business process instances, e.g., based upon changes to the context associated with the business process instance.

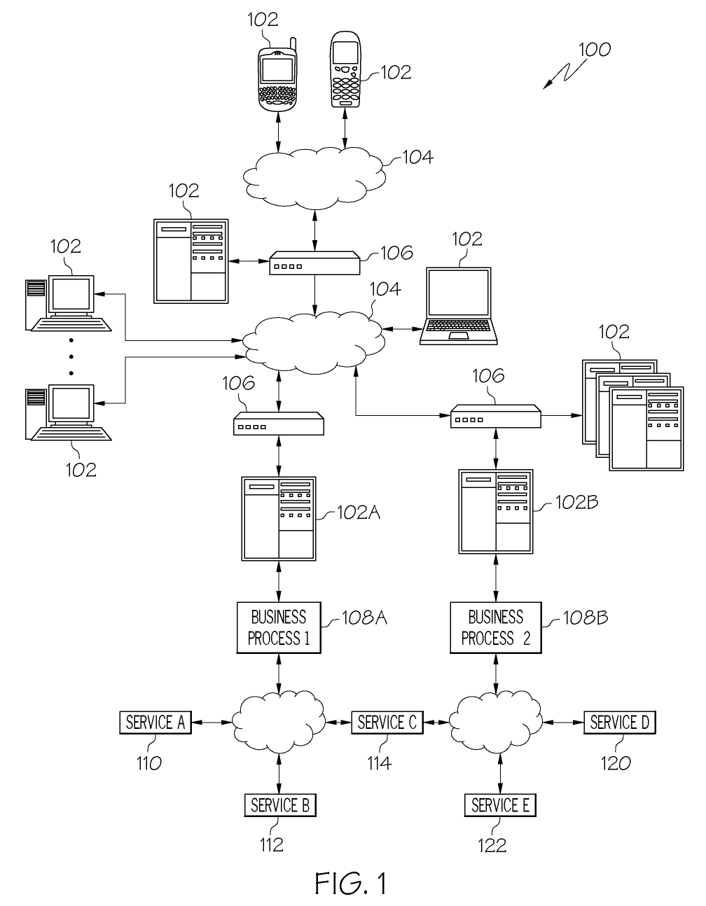

Referring now to the drawings and particularly to FIG. 1, a general diagram of a computer system 100 is illustrated. The computer system 100 comprises a plurality hardware and/or software processing devices, designated generally by the reference 102 that are linked together by a network 104. Typical processing devices 102 may include servers, personal computers, notebook computers, transactional systems, purpose-driven appliances, pervasive computing devices such as a personal data assistant (PDA), palm computers, cellular access processing devices, special purpose computing devices, printing and imaging devices, facsimile devices, storage devices and/or other devices capable of communicating over the network 104. The processing devices 102 may also comprise software, including applications and servers that process information stored in various databases, spreadsheets, structured documents, unstructured documents and/or other files containing information.

The network 104 provides communications links between the various processing devices 102, and may be supported by networking components 106 that interconnect the processing devices 102, including for example, routers, hubs, firewalls, network interfaces wired or wireless communications links and corresponding interconnections. Moreover, the network 104 may comprise connections using one or more intranets, extranets, local area networks (LAN), wide area networks (WAN), wireless networks (WIFI), the Internet, including the world wide web, and/or other arrangements for enabling communication between the processing devices 102, in either real time or otherwise, e.g., via time shifting, batch processing, etc. The system 100 is shown by way of illustration, and not by way of limitation, as a computing environment in which various aspects of the present invention may be practiced.

A user interface or other suitable software tool may be used to define and implement an organization's business processes by specifying flows of information and transforming the specified flows of information into corresponding composition applications. In an illustrative example, assume that a select one of the processing devices is further designated 102A. Also assume that processing device 102A implements a first business process application 108A (BUSINESS PROCESS 1). Still further, for purposes of illustration, assume that another select one of the processing devices is further designated 102B. Also assume that processing device 102B implements a second business process application 108B (BUSINESS PROCESS 2). The first and second business process applications 108A, 108B may comprise, for example, web-based applications, intermediate applications that interacts with other applications across the network 104, or any other applications that can be assembled from or utilize one or more component services.

The first and second business process applications 108A, 108B may be assembled using loosely coupled and typically independent software services to support the requirements of business processes and software users, such as in a “service oriented architecture” (SOA) environment. In this regard, the software services, e.g., web services, are designed to support interoperable machine-to-machine interaction over the network 104 where each web service may be stored and executed on a remote system that communicates with the requesting system, e.g., using Simple Object Access Protocol (SOAP)-formatted extended markup language (XML) commands.

To further the above-example, assume that the first business process application 108A is executed by an assembly of three component services (web services) 110, 112, 114, also designated as Service A, Service B and Service C, respectively. Further assume that the second business process application 108B is executed by an assembly of three component services 114, 120, 122, also designated as Service C, Service D and Service E, respectively. Each of the component services 110, 112, 114, 120 and 122 may be provided by third party service providers and may thus be distributed across one or more additional processing devices 102 that communicate with each other as necessary to implement the corresponding flow via the network 104. To promote deployment by service providers and other third party entities, web services may be constructed based on industry standard technologies, such as the Web Service Definition language (WSDL) to describe web services, Universal Description, Discovery and Integration (UDDI) to advertise and syndicate web services, and Service Oriented Architecture Protocol (SOAP) to enable web services to communicate.

The first and second business process applications 108A, 108B each define a flow of interrelated tasks that solve a particular issue of interest to a corresponding business entity, and thus define a business process. In an exemplary implementation, to execute either the first business process application 108A or the second business process application 108B, a specific instance of the corresponding business process is instantiated. The specific business process instance is executed based upon a determined execution priority as will be described in greater detail herein.

Each component service 110, 112, 114, 120, 122 is a self-contained, modular business process application, i.e., web service, that implements at least one activity in the business process flow of its corresponding business process applications 108, 118, etc. Moreover, each component service 110, 112, 114, 120, 122 is able to implement at least one function, role, action, computation or other defined process, e.g., decision points, branches, joining points and loops that may be utilized by one or more business processes. As such, the component service 114 is shown as being part of the business flow of both business process applications 108A, 108B for purposes of illustration.

When a business process application instance invokes a component service, e.g., when business process application 108A invokes component service 110, a specific component service instance of SERVICE A is instantiated to interact with the business process application instance. In a general sense, each component service 110, 112, 114, 120 and 122 is itself a business process and may thus have a priority dynamically assigned thereto as described in greater detail herein. However, because the component services 110, 112, 114, 120 and 122 are instantiated for execution in the context of a service, e.g., a web service, these business process applications are also referred to herein as service instances.

According to an aspect of the present invention, depending on the priority of the corresponding business process instance, there may be assigned/negotiated a different priority for the various service instances (such as web services) that the business process instance invokes. As an example, the specific priority level associated with an instance of component service 112 may be dependent upon the priority level associated with the corresponding instance of the business process application 108A, etc.

The business entity associated with the business flow corresponding to the first business process application 108A may have service level agreements with each of the providers of component services 110, 112 and 114. Similarly, the business entity associated with the business flow corresponding to the second business process application 108B may have service level agreements with each of the providers of component services 114, 120 and 122. Each service level agreement typically specifies the mutual understandings, guarantees and expectations of a service to perform as part of a designated business process flow. Moreover, as shown, the first business process application 108A and the second business process application 108B each utilize component service 114 (SERVICE C). In this regard, the provider of Service C may have service level agreement with the entity corresponding to the first business process 108A that sets out different terms than a service level agreement between the provider of Service C and the entity corresponding to the second business process application 108B.

According to various aspects of the present invention, business processes, e.g., executed instances of the component services 110, 112, 114, 120 and 122 may not be statically defined to a class of service when initiated. Rather, the class of service and corresponding priority associated with any specific instance can be determined dynamically based upon a predefined context, e.g., at the point of instantiation. Moreover, the execution priority level may be dynamically adjusted during execution of the instance, e.g., based upon detecting or recognizing changes to a corresponding context.

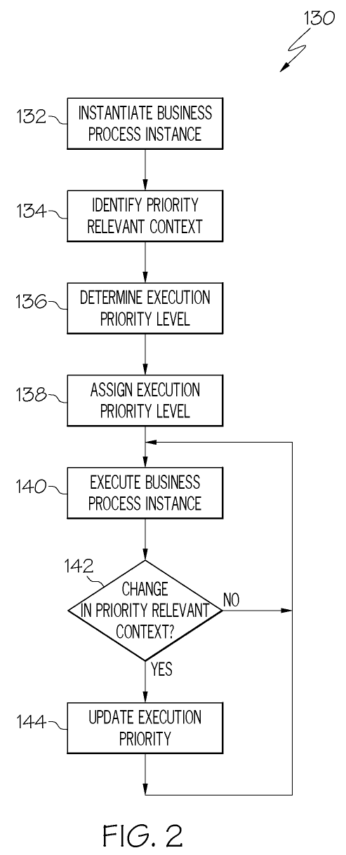

Referring to FIG. 2, a method 130 for dynamically prioritizing business processes is illustrated according to various aspects of the present invention. The method 130 instantiates a specific business process instance corresponding to a business process flow to be executed at 132. For example, each of the first and second business process applications 108A, 108B defines a corresponding business process flow. The flow is carried out by component services 110, 112, 114, 120 and 122, which each execute business processes corresponding to the overall business process flow. Each time a component service 110, 112, 114, 120 and 122 is called by its corresponding business process application 108A, 108B, a corresponding system instantiates a service instance to carry out its assigned task within the corresponding business flow.

A priority relevant context is identified and is associated with the business process instance at 134. An execution priority level is determined for the business process instance from at least two priority levels associated with the business process based at least upon the priority relevant context at 136. The execution priority level is assigned to the business process instance at 138 and the business process instance is executed at 140 based upon the priority level.

According to an aspect of the present invention, a software system, middleware or framework may utilize priority bands where each band comprises more than one fixed level or class to dynamically select a priority level for a given business process instance. For example, a context associated with a business process instance, e.g., a current value of a predetermined variable may be utilized to set where in a priority band the business process instance executes. That is, the value of the predetermined variable is used to select a priority level for the business process instance within a range determined by a corresponding priority band. As noted in greater detail above, minimum and maximum priorities may set bounds on a given priority band. Alternatively, a given priority band may not have a minimum bound. Still further, there may be no upper limit to a given priority band.

Moreover, the context utilized to determine the execution priority level of the business process instance may comprise, for example, the current value of a variable or variables, which may be associated with the corresponding business flow, may be outside the business flow, or may be unrelated to the business flow. Still further, directives, e.g., rules including policies, algorithms and other factors may be considered within a given context to determine a priority level for an associated business process instance. Still further, a priority level may be determined based upon dependent data aggregated from processes downstream in flow of the given business process instance.

According to further aspects of the present invention, a dynamically derived priority level may be changed during execution of the business process based upon some context. For example, a further aspect of the method 130 may comprise determining whether a change has been detected in the priority relevant context of the business process instance at 142. If no change has been detected, the method continues to execute the business process instance at 140 at its current priority. If a change is detected, the execution priority of the business process instance is updated at 144. If the business process priority is changed at 144, it may also be necessary to adjust resources allocated to the business process instance, e.g., to account for the changed priority in view of an existing service level agreement. As an example, directives, e.g., rules including policies, algorithms and other factors may be considered within a given context to determine if a priority level for the business process instance should be changed to a different priority level, and optionally, if a change should occur, what priority level the business process instance should be changed to. Priority changes to a business process instance may also change the priorities of the services that comprise the business process as set out in greater detail herein.

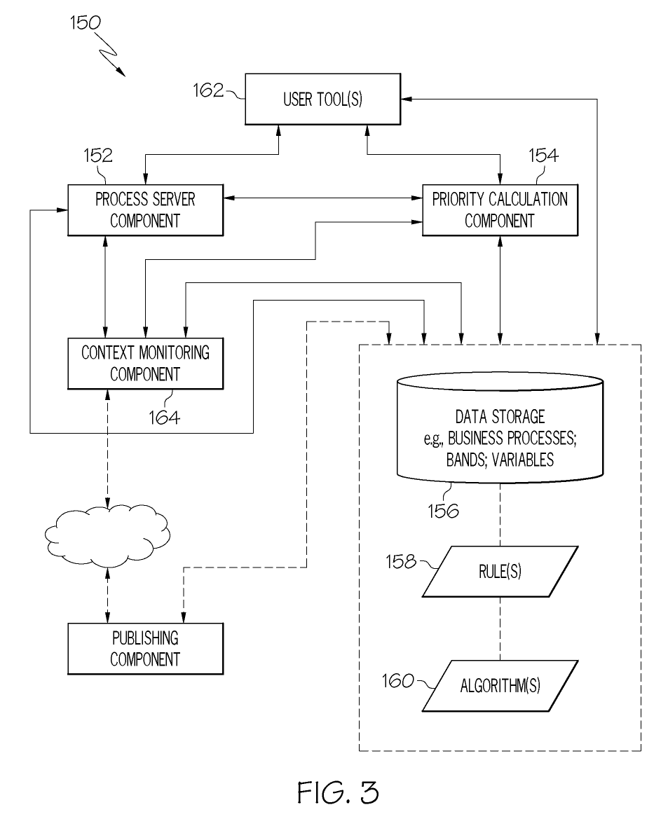

Referring to FIG. 3, an exemplary system 150 that dynamically prioritizes business processes is illustrated according to various aspects of the present invention. The system 150 comprises a process server component 152 and a priority calculation component 154. The process server component 152 instantiates business process instances and may comprise, for example, a WebSphere Process Server (WPS) by IBM. According to an aspect of the present invention, the process server may identify the context, e.g., the variables, from which the priority level of each instantiated business process is to be evaluated. According to another aspect of the present invention, the priority calculation component identifies the context. In yet another aspect of the present invention, the context is identified by some combination of the process server, the priority calculation component and/or a third party component. The priority calculation component 154 determines and assigns a unique priority level to each business process instance. For example, the priority calculation component 154 may access a data source 156 that stores a table lookup to establish priority. The table lookup may store information that defines two or more priority levels for an associated business process as a priority band. Still further, the priority calculation component 154 may access directives such as rules 158 and algorithms 160 to determine the priority level for specific business process instances.

According to an aspect of the present invention, user tool(s) 162 are provided to allow a user, e.g., an administrator, to set up, manage, maintain, modify, etc., the system for dynamically setting business process prioritization. For example, priority levels for specific business process instances are selected from a corresponding priority band. In this regard, a user tool 162 may be provided for setting up the bands, which may be stored in the table lookup 156. The user tool 162 may comprise a build time, deployment time or run-time tool (or combination thereof) that queries a user such as an administrator for minimum and/or maximum bounds for a given priority band (if bounds are necessary). The user tool 162 may also allow an administrator to establish, edit, delete or otherwise manipulate directives such as the rules 158 and algorithms 160.

Still further, the user tool(s) 162 may allow a user to establish the context that is used to determine priority. The user tool 162 provides the user a tool to map data dependent priorities to specific business process instances. As noted in greater detail herein, the data dependencies may be established based upon variables in the business process, variables associated with the business process and/or data variables that are external to, or otherwise unrelated to the business process. As such, the user tool 162 allows a user to map selected variables or combinations of selected variables to corresponding priorities.

Still further, the user tool(s) 162 may allow a user to establish directives, such as the rules 158 and algorithms 160 discussed above, to map variables to priorities. As yet another illustrative example, the user tool(s) 162 may allow a user to aggregate dependent data from processes downstream in flow for use in calculating a current process stream priority.

The priority of a business process instance may change once, or even multiple times in its execution. As such, the system 150 may further comprise a context monitoring component 164. The context monitoring component 164 monitors the context, e.g., variables, that affect priority of business process instances. If a change in a variable is detected, the change information is passed along to the priority calculation component 154 so that the change in variable value can be reflected in the current priority of the associated business process instance or service instances comprising the business process. For example, with the change of priority, the system 150 may dynamically adjust resources utilized by the system. The dynamic adjustment of resources may also trigger a change in the priority or execution in one or more component web services utilized in the implementation of the business process instance. Further, a change in the priority of a business process instance may also trigger the system to change workload balancing based upon the new priority

Dynamic adjustment of priorities may be implemented explicitly, e.g., by making adjustments within an application or applications associated with the implementation of the corresponding business process instance. The current priority of the business process instance may also be raised or lowered due to actions internal to the business process. As an example, a data result in the business process flow may trigger an action that modifies the priority. Alternatively, the current priority of the business process instance may be raised or lowered due to actions external to the business process. Still further, dynamic adjustments may be implemented implicitly, e.g., as a result of the dynamically changing priority. For example, a detected external price change for dependent resources, such as a fluctuating cost to services later in the business process flow requiring actions to be more critical can impact a priority of the a corresponding business process.

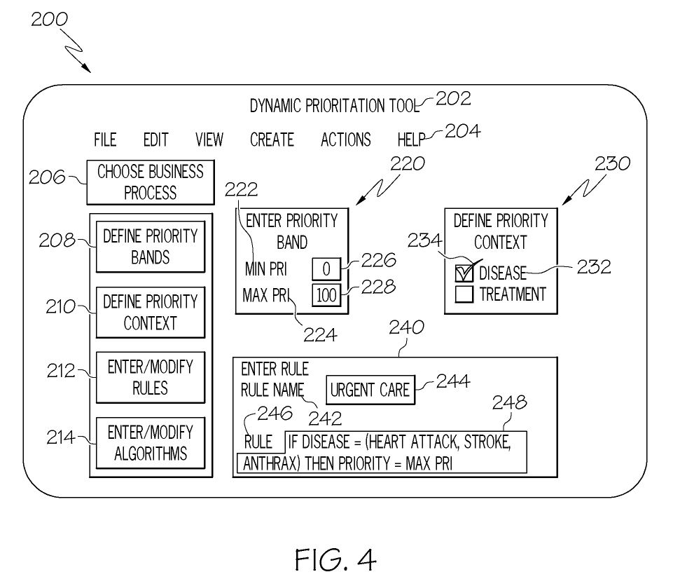

Referring to FIG. 4, a screen shot illustrates an exemplary user interface 200 that may be utilized to facilitate user interaction as part of the processing implemented by the user tool 162. The title 202 of the screen is shown generally towards the top of the screen and the exemplary text “Dynamic Prioritization Tool” is shown for illustrative purposes. The user interface 200 also includes a set of menu options 204, such as standard drop down menu items including File, Edit, View, Create, Actions, and Help as is typically utilized in graphic user interface programs.

A first control 206 may be selected by a user to identify a business processes to which dynamic prioritization is to be defined, modified, deleted or otherwise adjusted. A second control 208 may be selected by the user to define Priority Bands, such as set out in greater detail herein. A third control 210 may be selected by the user for defining a priority relevant context, which is utilized in making determinations of a priority level for a given business process instance. A fourth control 212 may be selected by the user to enter and/or modify rules, and a fifth control 214 may be utilized by the user to enter and/or modify algorithms associated with establishing priority. The first through fifth controls 206, 208, 210, 212, 214 allow a user to map data dependent priorities to specific business process instances as described below.

In the illustrative example, it is assumed that the user has selected the first control 206, and has already selected a business process, e.g., a business process for processing medical/patient information in the example. The first control 206 may launch a first module that displays a window or other display mechanism to show a pick list (not shown) or other arrangement of business processes from which a user may select. This list could be populated by programmatic linkage between the Priority tool 162 and other aspects of the business process system as shown for example in FIG. 3.

The second control 208 may launch a second module that defines at least two different priority levels that correspond to the business process, where a select one of the different priority levels is designated an execution priority level that is subsequently assigned to a specific instance of the business process as described above. For example, as shown, the second module displays a priority band window 220. The priority band window 220 is illustrated as having been pre-configured to prompt for a Band defined by a minimum priority 222, designated “MinPri”, and maximum priority 224 designated “MaxPri”. The window 220 also includes a first field 226 for allowing the user to enter a user-defined minimum priority, and a second field 228 for allowing the user to enter a user-defined maximum priority. The user has entered the values “0” for the minimum priority 222 (MinPri) and the user has entered the value “100” for the maximum priority 224 (MaxPri). The window 220 may include additional information (not shown), such as default values for the minimum priority 222 (MinPri) and/or the maximum priority 224 (MaxPri). The window 220 may also optionally include input fields for information such as “step size” or interval, which sets the resolution of priority levels between the user-designated minimum and maximum values.

The third control 210 may launch a third module to define a priority relevant context associated with the business process, where the priority relevant context is evaluated to select an execution priority level for a specific instance of the business process. For example, as shown, the third module displays a priority relevant context window 230. As shown, the priority relevant context window 230 has been preconfigured to present options in the form of check boxes to the user to define a priority relevant context. For purposes of illustration, the window 230 includes a list 232 of pre-configured variables from which the user may select for establishing the priority relevant context of the associated business process. For example, the list 232 may be pre-configured to list the variables in or otherwise associated with the business process and/or variables external to the selected business process, e.g., variables in the data base to which the business process is attached. In this manner, variables to be used in the priority relevant context can be chosen, e.g., simply by checking a box, selecting a toggle button, etc.

As shown, there are two variables, labeled “Disease” and “Treatment”. In the illustrative example, the user has selected the variables “Disease” as a priority relevant variable by clicking the cursor (not shown) on the box to the left of disease, thus designating the variable as the priority relevant context, which is graphically indicated by the check mark 234. Other and/or additional variables may also be selected to associate with a priority relevant context for the business process. For example, by selecting the third control 210 a second time may allow input of additional variables, allowing the full choice of variables for the priority relevant context.

The user may also utilize a fourth module to define at least one directive that is evaluated in consideration of the priority relevant context in order to select an execution priority level. Exemplary directives include for example, rules and algorithms. For example, when a user selects the fourth control 212, the fourth module displays a rules window 240. As shown, the user has selected the fourth control 212 and the rules window 240 has presented options to the user. As an illustrative example, the user may be prompted for a rule name 242 at field 244 and the user has responded by entering the name “Urgent Care” in the field 244. The window 240 also includes a prompt for a rule 246 at rule field 248. As an illustrative example, the user has entered the rule: “If Disease=(heart attack, stroke, anthrax) then priority=Max Pri” in the rule field 248. This rule will set the priority to the value associated with the maximum priority value 228 (Max Pri) if one or more of these (serious) conditions is present. That is, in the illustrative example, the rule “Urgent Care” maps a specific priority level (the value of Max Pri) to at least one value of the variable “Disease”. As shown, the rule corresponds to the user selection of the variable “Disease” in the priority relevant context window 230. In general, any number of rules may be created. Moreover, the rules may utilize any number of variables, events, conditions or other knowledge that is available to the system at the time that the corresponding rule is evaluated. The window 240 may also allow the user to select, review, modify, delete and/or otherwise manipulate other existing rules as well. Accordingly, search tools, selection tools, etc. may be provided to facilitate recall of existing rules.

A window and corresponding prompts, fields and commands may also be presented to allow the user to select, modify, delete or otherwise manipulate algorithms, such as may be presented in response to the user selecting the fifth control 214. In this regard, the prompts, fields, commands, etc. may be similar and/or analogous to the tools, windows, etc. described above with reference to the interface 200 in general.

Although the user interface 200 is shown using various buttons, configuration boxes, check boxes, message boxes, windows, prompts, fields, menu options, etc., other formats and presentations may alternatively be implemented. Further, the content itself may be different from that shown, e.g., depending upon the manner in which priority is associated to business process instances.

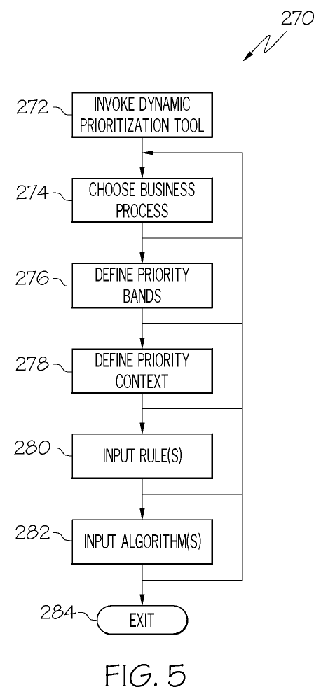

Referring to FIG. 5, a flow chart 270 illustrates the execution of a dynamic prioritization tool, e.g., the user tool(s) 162. The user invokes the dynamic prioritization tool at 272. The invocation of the dynamic prioritization tool can be from the operating system normal method for program invocation, from an Interactive Development Environment (IDE) such as Eclipse or IBM Rational Application Developer or by other means of program invocation. The business process for association with dynamic prioritization is selected at 274, such as by selecting the first control 206 in the user interface 200 shown in FIG. 4 and by selecting a desired business process from a pick list, by name or by other methods, further examples of which are set out with reference to FIG. 4, above. At least two different priority levels are defined at 276 that correspond to the business process, wherein a select one of the priority levels is designated an execution priority level that is subsequently assigned to a specific business process instance, such as during instantiation as described in greater detail herein with reference to FIGS. 2-4. The priorities are chosen, such as by identifying a range of priorities, e.g., by defining a priority band. The priority band may be set up, for example, using the second control 208 described in greater detail with reference to FIG. 4.

The priority relevant context associated with the business process is defined at 278. The definition of the priority relevant context may be implemented, for example, from a pick list of variables associated with the business process. The selection of a priority relevant context may be established, for example, using the third control 210 described in greater detail with reference to FIG. 4. During execution, the priority relevant context may be evaluated to select an execution priority level for a specific instance of the selected business process from the corresponding previously defined priority levels

Additionally, directives may be defined and input into the system. For example, at least one rule associated with prioritization of the business process may be defined and input to the system at 280. The rule(s) are evaluated in consideration of the priority relevant context in order to select the execution priority level, e.g., during execution as described more fully herein. The selection of one or more rules, when utilized, may be established, for example, using the fourth control 212 described in greater detail with reference to FIG. 4. As another example, at least one algorithm associated with prioritization of the business process may be defined and input to the system at 282. The selection of one or more algorithms, when utilized, may be established, for example, using the fifth control 214 described in greater detail with reference to FIG. 4. When the user has completed all desired processing, the process can be exited at 284.

The processing and flow with regard to choosing a business process at 274, defining priority bands at 276, defining a priority relevant context at 278, defining rules at 280, defining algorithms at 282 etc., can be performed in any order. As an example, a user may want to define a rule first and subsequently associate the rule with a business process. Moreover, any of the above-defined processes may be repeated iteratively as necessary, e.g., to create multiple rules for a selected business process, to manipulate multiple business processes, etc.

With reference to FIGS. 2-5 in general, assume that a business process instance is to be executed on the process server 152. A business process is instantiated at 132 and one or more variables associated with the business process are identified as being input to the execution priority at 134. For example, the user tool 162 may be used to interface a user such as an administrator with the process server 152 or the priority calculation component 154 or third party component not shown (or some combination thereof) to identify one or more variables that determine the context in which the priority of the business process instance is established and optionally maintained. At a predetermined time, e.g., at instantiation time, the priority calculation component 154 examines the identified variables and potentially other information that may be of interest in determining priority. Using a suitable processing mechanism, e.g., accessing an associated table lookup such as a priority table stored the data storage 156, considering associated rules 158 and/or algorithms 160 the priority calculation component 154 calculates an execution priority for the business process instance at 136. The computed priority level is associated with the business process at 138. For example, it may be necessary to communicate the priority level to a corresponding operating system, to a web services application, to the process server 152 and/or to other hardware or software or network resources.

The business process instance is executed at 140. During execution, the context monitoring component 164 may monitor the associated variables that were initially used to establish a priority level for the business process instance. If a change is detected in one or more of the variables at 142, such as by the context monitoring component 164, the priority calculation component 154 is re-engaged to compute a new priority level at 144, and a new priority level may be established at 144. The updated priority level is then communicated to necessary hardware/software/network resources as set out in greater detail herein. The business process instance continues to execute at the new priority level unless it is changed again.

As noted in greater detail above, the execution priority level may be dynamically adjusted during execution of the instance, e.g., based upon detecting or recognizing changes to the corresponding context. For example, changes in a context may be determined by polling or otherwise interrogating one or more variables to see if their values have changed. As another example, triggers may be used to detect changes in a context, such as by executing a trigger script when a variable is changed where the trigger script may include communicating the change to the priority calculation component, etc. Still further, changes in context may be implemented using a publish/subscribe technique, where changes of variables are published and the priority calculation component subscribes to publication to detect the changes in the desired context.

According to further aspects of the present invention, the system 150 may be configured such that, depending on the priority of the business process instance, there may be assigned/negotiated a different priority for the various service instances (such as web services) that the process instance invokes.

Referring back to FIG. 1, it may be that the business that operates the business server 102A purchases, rents, leases or otherwise contracts with a software provider to acquire the use of the first business process application 108A. The software provider may be a software intermediate that assembles the first business process application 108A by developing and/or acquiring rights to use each of the component services 110, 112, 114, e.g., from third party service providers, from proprietary sources or from other resources. Thus, the software provider may make certain guarantees, warranties or other assurances to the business as to the fitness of the first business process application 108A. The software provider may thus, also require certain guarantees, warranties or other assurances from the various component services. By having the ability to dynamically adjust the priority of specific business process instances, the systems can adjust to improve the likelihood of meeting the guarantees, warranties and other assurances, as may be specified in a service level agreement.

As noted above, various aspects of the present invention allow the determination of priority, such as based on data unique to that instance of the transaction. For example, assume in the exemplary field of health care, at least a part of the first business process application 108A comprises testing people for health. In a conventional system, the priority of all transactions related to testing people for health would be the same. However, according to various aspects of the present invention, the dynamic adjustment of priority for specific business process instances allows, for example, the priority of a first instance to be different from a second instance. As such, a first business process instance, e.g., a transaction for testing the health of a person who has previously had a heart attack, highly communicable disease, life threatening condition, etc., may have a higher priority than a second business process instance, e.g., a transaction for testing the health of a young, healthy person with no medical history.

The above example is presented by way of illustration, and not by way of limitation, of a system including dynamically adjustable priorities based upon context. Further, the process definition itself may change dynamically. As an example, assume that the first business process application 108A is constructed using a business process modeling language such as the Business Process Execution Language (BPEL). According to various aspects of the present invention, the first business process application 108A may be constructed as a self-modifying BPEL program that can change its function. As such, the system may dynamically adjust the execution priority of a corresponding self-modifying business process instance, based at least in part upon a state of the self-modifying business process instance. The self-modifying business process instance may further dynamically adjust to be commensurate with the assigned execution priority of the specific business process instance.

Further examples may include considering other automated modifications of the business process, or human and/or autonomous modification such as in a “situational application”. Given that a varying number of process steps, with associated varying degrees of required resource, a dynamic modification of priority may also be required. In this regard, new transaction steps may be added, transaction steps may be removed or otherwise modified based upon priority. Keeping with the above medical example, a specific business process instance, e.g., a person having a known allergy may require an extra or different approval step for a prescription associated with the health checkup compared to a healthy person, and this extra step can be dynamically added to the business process application instance associated with the person having the known allergy.

Service level agreements may be managed in a dynamic priority environment for situational processes by evaluating the time for end to end processing when processing steps are added or subtracted, and modify the associated band accordingly.

As a further example, assume that payroll must be paid on Friday. The non-exempt employees must be paid accurately so their “time cards” must be processed. There is no time card processing for exempt employees. Normally the time cards are scanned in Thursday and the payroll is run as a medium priority job Thursday night. Now assume that the time cards have been damaged. Under this arrangement, the payroll process is modified to include a transaction that requires a user to manually enter the time card information. To make sure that clerks performing the input give this priority, the priority of payroll processing for a non-exempt employee is raised to high. However as not to impact the resources powering the company's e-commerce site, the priority of payroll processing of the exempt employees remains at a medium priority. This may allow, for example, the exempt employee payroll processing to run in the background. This is an example of business process running at different priorities based on data in the process, in this case, exempt or non-exempt.

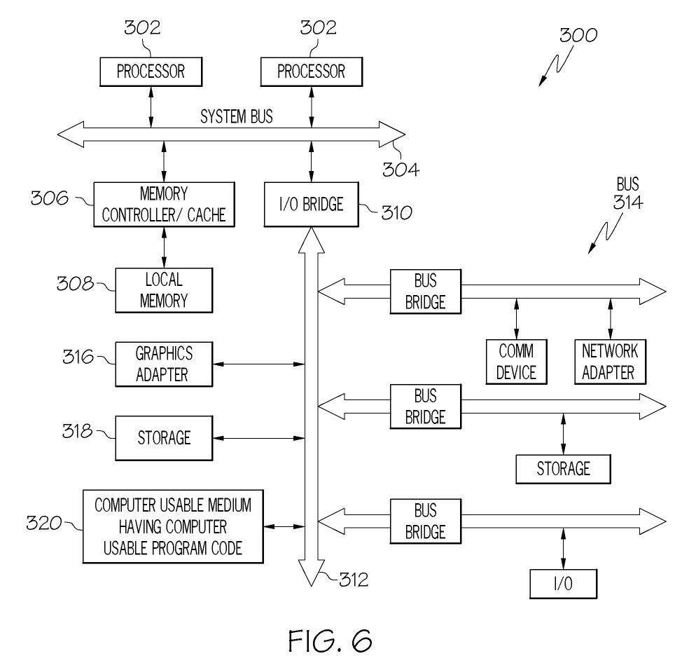

Referring to FIG. 6, a block diagram of a data processing system is depicted in accordance with the present invention. Data processing system 300, such as one of the processing devices 102 described with reference to FIG. 1, may comprise a symmetric multiprocessor (SMP) system or other configuration including a plurality of processors 302 connected to system bus 304. Alternatively, a single processor 302 may be employed. Also connected to system bus 304 is memory controller/cache 306, which provides an interface to local memory 308. An I/O bus bridge 310 is connected to the system bus 204 and provides an interface to an I/O bus 312. The I/O bus may be utilized to support one or more busses and corresponding devices 314, such as bus bridges, input output devices (I/O devices), storage, network adapters, etc. Network adapters may also be coupled to the system to enable the data processing system to become coupled to other data processing systems or remote printers or storage devices through intervening private or public networks.

Also connected to the I/O bus may be devices such as a graphics adapter 316, storage 218 and a computer usable storage medium 320 having computer usable program code embodied thereon. The computer usable program code may be executed to execute any aspect of the present invention, for example, to implement any aspect of any of the methods illustrated in FIGS. 2 and 5. Moreover, the computer usable program code may be utilized to implement the process server component 152, the priority calculation component 154, the user tools 162, the context monitoring component 164 or any other processes described with reference to FIG. 3, the user interface 200 described with reference to FIG. 4, or any other processes that are used to dynamically adjust business process priority based upon context as set out further herein.

The data processing system depicted in FIG. 6 may be, for example, an IBM RS/6000 system, a product of International Business Machines Corporation in Armonk, N.Y., running the Advanced Interactive Executive (AIX) operating system. An object oriented programming system such as Java may run in conjunction with the operating system and provides calls to the operating system from Java programs or applications executing on data processing system.

The various aspects of the present invention may be embodied as systems, computer-implemented methods and computer program products. Also, various aspects of the present invention may take the form of an entirely hardware embodiment, an entirely software embodiment (including software, firmware, micro-code, etc.) or an embodiment combining software and hardware, wherein the embodiment or aspects thereof may be generally referred to as a “circuit,” “component” or “system.” Furthermore, the various aspects of the present invention may take the form of a computer program product on a computer-usable storage medium having computer-usable program code embodied in the medium or a computer program product accessible from a computer-usable or computer-readable medium providing program code for use by or in connection with a computer or any instruction execution system.

The software aspects of the present invention may be stored, implemented and/or distributed on any suitable computer usable or computer readable medium(s). For the purposes of this description, a computer-usable or computer readable medium can be any apparatus that can contain, store, communicate, propagate, or transport the program for use by or in connection with the instruction execution system, apparatus, or device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium. As yet further examples, a computer usable or computer readable medium may comprise cache or other memory in a network processing device or group of networked processing devices such that one or more processing devices stores at least a portion of the computer program product. The computer-usable or computer-readable medium may also comprise a computer network itself as the computer program product moves from buffer to buffer propagating through the network. As such, any physical memory associated with part of a network or network component can constitute a computer readable medium.

More specific examples of the computer usable or computer readable medium comprise for example, a semiconductor or solid state memory, magnetic tape, an electrical connection having one or more wires, a swappable intermediate storage medium such as floppy drive or other removable computer diskette, tape drive, external hard drive, a portable computer diskette, a hard disk, a rigid magnetic disk, a random access memory (RAM), a read-only memory (ROM), an erasable programmable read-only memory (EPROM or Flash memory), a portable compact disc read-only memory (CD-ROM), a read/write (CD-R/W) or digital video disk (DVD), an optical fiber, disk or storage device, or a transmission media such as those supporting the Internet or an intranet. The computer-usable or computer-readable medium may also comprise paper or another suitable medium upon which the program is printed or otherwise encoded, as the program can be captured, for example, via optical scanning of the program on the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wire line, wireless, optical fiber cable, RF, etc.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

The present invention is described with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by system components or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods and/or systems disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

The flowchart and block diagrams in the Figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A method of establishing dynamic prioritization of business process instances comprising:
selecting a business process for association with dynamic prioritization;
defining at least two different priority levels that correspond to said business process;
defining a priority relevant context associated with said business process, said priority relevant context evaluated to select an execution priority level from said at least two different priority levels for association with each instance of said business process that has been instantiated;
defining at least one directive that is evaluated in consideration of said priority relevant context in order to select said execution priority level; and
storing said priority levels and said priority relevant context in a storage device accessible to a priority calculating component for calculating priorities of business process instances using said priority levels and said priority relevant context.

2. The method according to claim 1, wherein said selecting a business process for association with dynamic prioritization comprises:
providing a list of available business processes and receiving a user selection of a desired business process for dynamic prioritization.

3. The method according to claim 1, wherein said defining at least two different priority levels that correspond to said business process comprises:
receiving user input in defining a band that specifies at least two priority levels.

4. The method according to claim 3, wherein said receiving user input in defining a band that specifies at least two priority levels comprises:
prompting a user to provide a minimum priority level; and
prompting said user to provide a maximum priority level.

5. The method according to claim 1, wherein said defining a priority relevant context associated with said business process comprises:
providing a list of variables derived from at least one of the variables used by said selected business process and variables provided in a database to which said selected business process is attached; and
defining said priority relevant context to include at least one variable that is selected by a user from said list of variables.

6. The method according to claim 1, wherein said defining a priority relevant context associated with said business process comprises:
defining said priority relevant context as data dependencies established based upon variables associated with the selected business process.

7. The method according to claim 1, wherein said defining a priority relevant context associated with said business process comprises defining said priority relevant context as data dependencies established based upon at least one variable that is external to, or otherwise unrelated to said business process.

8. The method according to claim 1, wherein said defining at least one directive that is evaluated in consideration of said priority relevant context in order to select said execution priority level comprises:
defining at least one rule that maps a specific priority level to at least one value of at least one variable selected by said user.

9. The method according to claim 1, wherein said defining at least one directive that is evaluated in consideration of said priority relevant context in order to select said execution priority level comprises:
defining at least one algorithm or rule that is evaluated in consideration of said priority relevant context.

10. The method according to claim 1, further comprising:
executing said method during at least one of build time, deployment time or run-time.

11. A method of providing a user interface to establish dynamic prioritization of business process instances comprising:
providing a first module that, when executed, selects a business process for association with dynamic prioritization;
providing a second module that, when executed, defines at least two different priority levels that correspond to said business process;
providing a third module that, when executed, defines a priority relevant context associated with said business process, said priority relevant context evaluated to select an execution priority level from said at least two different priority levels for association with a specific instance of said business process;
providing a fourth module that, when executed, defines at least one directive that is evaluated in consideration of said priority relevant context in order to select said execution priority level and
providing data storage to store said priority levels and said priority relevant context in a storage device accessible to a priority calculating component for calculating priorities of business process instances using said priority levels and said priority relevant context.

12. The method according to claim 11, wherein said providing a first module further comprises:
configuring said first module to, when executed, display lists of available business processes and receive a user selection of a desired business process for dynamic prioritization.

13. The method according to claim 11, wherein said providing a second module further comprises:
configuring said second module to, when executed, define a band that specifies at least two priority levels.

14. The method according to claim 13, wherein said providing a second module further comprises:
configuring said second module to, when executed, prompt a user to provide a minimum priority level and prompt said user to provide a maximum priority level.

15. The method according to claim 11, wherein said providing a third module further comprises:
configuring said third module to, when executed, display a list of variables derived from at least one of: variables used by said selected business process and variables provided in a database to which said selected business process is attached, and define said priority relevant context to include at least one variable from said list of variables that is selected by a user.

16. The method according to claim 11, wherein said providing a third module further comprises:
configuring said third module to, when executed, display a list of variables where a user selects at least one of said variables; and
configuring said fourth module to, when executed, allow a user to map a specific priority level to at least one value of at least one variable selected by said user.

17. The method according to claim 11, wherein said providing a third module further comprises:
configuring said third module to, when executed, define said priority relevant context as data dependencies established based upon variables associated with the selected business process.

18. The method according to claim 11, wherein said providing said third module further comprises:
configuring said third module to, when executed, define said priority relevant context as data dependencies established based upon at least one variable that is external to, or otherwise unrelated to said business process.

19. The method according to claim 11, wherein said providing said fourth module further comprises:
configuring said fourth module to define at least one algorithm or at least one rule that is evaluated in consideration of said priority relevant context in order to select said execution priority level.

20. The method according to claim 11, further comprising executing said user interface during at least one of build time, deployment time or run-time.
